(19) United States
(12) Patent Application Publication
(10) Pub. No.: US 2011/0007854 A1
(43) Pub. Date: Jan. 13, 2011

(54) INTEGER CARRIER FREQUENCY OFFSET ESTIMATION SCHEME FOR ORTHOGONAL FREQUENCY DIVISION MULTIPLEXING

(75) Inventor: Yushan Li, Shanghai (CN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/921,122

(22) PCT Filed: Mar. 6, 2009
(86) PCT No.: PCT/IB09/50935

§ 371 Date: Sep. 3, 2010

(30) Foreign Application Priority Data
Mar. 6, 2008 (US) 61034445

(51) Int. Cl. H04L 27/06

(52) U.S. Cl. 375/344

(57) ABSTRACT

A coarse integer carrier frequency offset CFO compensator (138) for an orthogonal frequency division multiplexor OFDM receiver. The coarse integer CFO compensator includes a subcarrier grouping engine (146), a signal power calculator (148), and a search range identifier (150). The subcarrier grouping engine groups a plurality of subcarriers into two groups based on a coarse acquisition range parameter, Q, corresponding to a coarse acquisition range. The signal power calculator identifies a coarse estimate of an integer CFO based on a computed maximum value of a signal power function. The signal power function is based on a constructed sequence of the plurality of subcarriers. The search range generator identifies a fine acquisition range. The fine acquisition range is narrower than the coarse acquisition range.

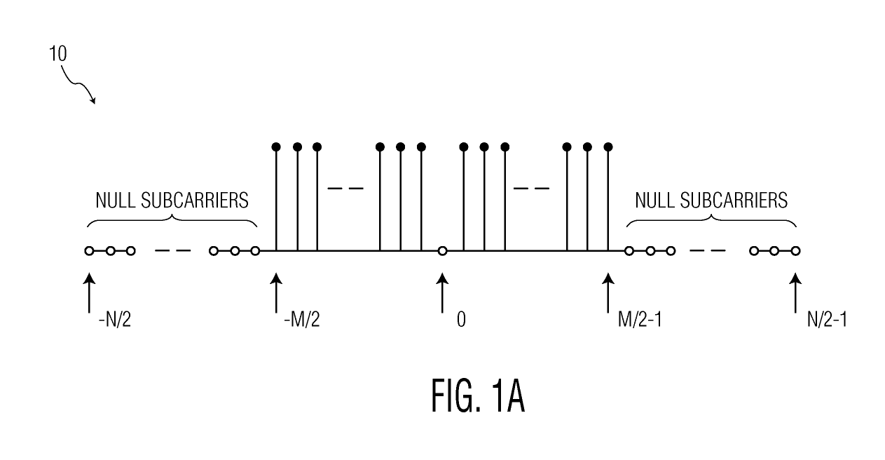

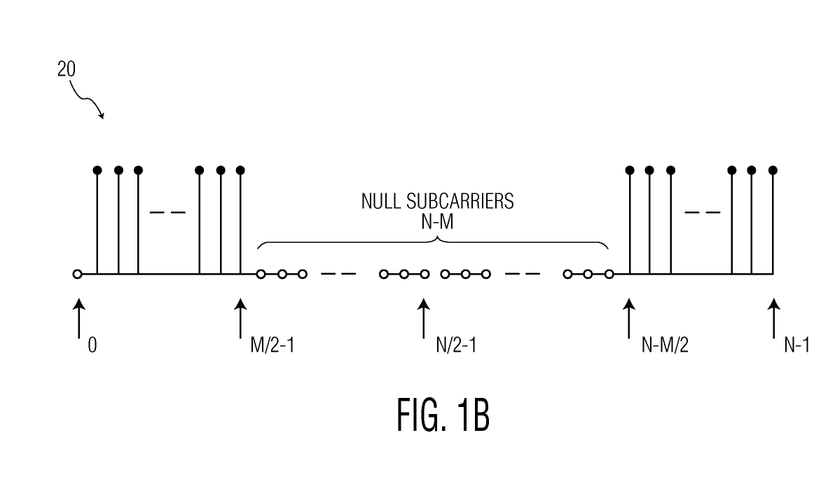

Embodiments of the invention relate generally orthogonal frequency division multiplexing (OFDM) communications and, more particularly, to integer carrier frequency offset (CFO) compensation within an OFDM communication system. OFDM is generally capable of providing high data rate transmission. FIG. 1A illustrates a conventional OFDM symbol subcarrier allocation 10. In particular, FIG. 1A depicts how OFDM communications may use null subcarriers, inserted at both sides of the spectrum, to facilitate filter design. FIG. 1B illustrates an exemplary fast Fourier transform (FFT) output of the OFDM symbol subcarrier allocation of FIG. 1A. In the depicted embodiment, there is no integer CFO. In FIGS. 1A and 1B, N represents a total number of null and non-null subcarriers, while M represents a total number of non-null subcarriers. Hence, the number of null subcarriers is N-M.

OFDM has a disadvantage of being sensitive to CFO. Hence, CFO compensation is a design consideration for receivers which are used in OFDM communications. CFO is mainly caused by the mismatch between the transmitter oscillator and the receiver oscillator. The CFO can be split into an integer part and a fractional part. The fractional CFO results in inter-carrier-interference (ICI) which destroys the orthogonality among subcarriers. Although the integer CFO does not disrupt the orthogonality property, it leads to a cyclic shift of the entire spectrum.

In practice, before decoding useful data, an OFDM receiver completes timing synchronization, CFO compensation, and channel estimation. A typical synchronization procedure includes coarse timing synchronization, fractional CFO compensation, integer CFO compensation, fine timing synchronization, and channel estimation. The details of the timing synchronization and the fractional CFO estimation are not discussed in detail herein. For convenience in discussing the integer CFO compensation in more detail, it may be assumed that the timing offset and the fractional CFO are adequately compensated.

Conventional techniques may be implemented to remove the frequency ambiguity caused by the integer CFO. These conventional algorithms can be classified into two categories: Blind methods and Semi-Blind methods. Existing semi-blind algorithms with relatively high accuracy often incur a substantial computational load to identify the correlation peak for all possible integer CFOs. As the acquisition range increases, the relatively high complexity becomes cumbersome and, at times, prohibitive. The computational complexity also causes a large delay to the reception within OFDM systems. On the other hand, conventional blind methods typically either incur an even higher complexity or are inaccurate under low signal-to-noise ratio (SNR) conditions. Therefore, it is a very challenging task to accurately estimate the integer CFO, using conventional techniques, without using a relatively complex design which incurs a substantial computational load.

As mentioned above, the integer CFO is typically caused by a mismatch between the transmitter oscillator and the receiver oscillator. The acquisition range for a practical OFDM system is associated with the carrier frequency, the subcarrier spacing, and the oscillator stability. For instance, for an OFDM system working on 2.68 GHz, if the oscillator has stability of 80 ppm, the acquisition range is ±214.4 kHz. For a system with this acquisition range, if the subcarrier spacing is 4.88 kHz, the acquisition range corresponds to ±44 subcarriers. In other words, the FFT output only potentially cyclically shifts right or left by 44 subcarriers, i.e., −44≦\tilde{ζ}_{I}≦44, where \tilde{ζ}_{I}, is a possible integer CFO.

Embodiments of an apparatus are described. In one embodiment, the apparatus is a coarse integer carrier frequency offset (CFO) compensator for an orthogonal frequency division multiplexor (OFDM) receiver. The coarse integer CFO compensator includes a subcarrier grouping engine, a signal power calculator, and a search range generator. The subcarrier grouping engine groups a plurality of subcarriers into two groups based on a coarse acquisition range parameter, Q, corresponding to a coarse acquisition range. The signal power calculator identifies a coarse estimate of an integer CFO based on a computed maximum value of a signal power function. The signal power function is based on a constructed sequence of the plurality of subcarriers. The search range generator identifies a fine acquisition range. The fine acquisition range is narrower than the coarse acquisition range. Other embodiments of the apparatus are also described.

Embodiments of an OFDM receiver are also described. In one embodiment, the OFDM receiver includes a receiver oscillator, a demodulator, and a synchronization module. The receiver oscillator generates an oscillation signal. The demodulator demodulates an OFDM signal from a transmitter. The synchronization module synchronizes the receiver oscillator with a transmitter oscillator at the transmitter. The synchronization module includes an integer CFO compensator to implement a coarse CFO estimation stage and a fine CFO estimation stage. The coarse CFO estimation stage provides a fine acquisition range for the fine CFO estimation stage. Other embodiments of the system are also described.

Embodiments of a method are also described. In one embodiment, the method is a method for compensating for an integer CFO at an OFDM receiver in an OFDM communication system. An embodiment of the method includes generating an oscillation signal at the OFDM receiver and generating a coarse integer CFO estimation for an OFDM signal received at the OFDM receiver. The method also includes generating a fine integer CFO estimation based on the coarse integer CFO estimation and synchronizing the oscillation signal at the OFDM receiver with a transmitter oscillation signal based at least partially on the fine integer CFO estimation. Other embodiments of the method are also described.

Other aspects and advantages of embodiments of the present invention will become apparent from the following detailed description, taken in conjunction with the accompanying drawings, illustrated by way of example of the principles of the invention.

FIG. 1A illustrates a conventional OFDM symbol subcarrier allocation.

FIG. 1B illustrates an exemplary fast Fourier transform (FFT) output of the OFDM symbol subcarrier allocation of FIG. 1A.

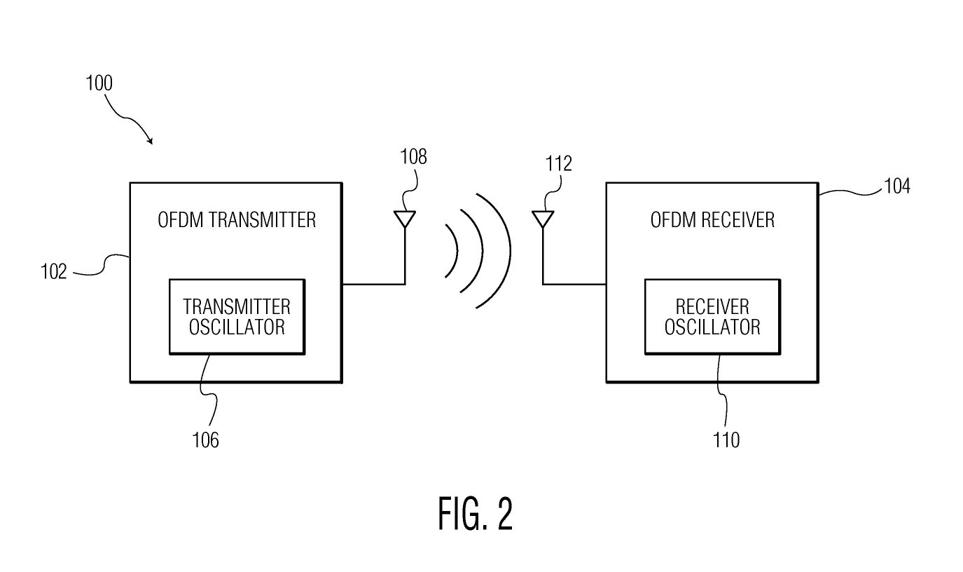

FIG. 2 depicts a schematic block diagram of one embodiment of an OFDM communication system.

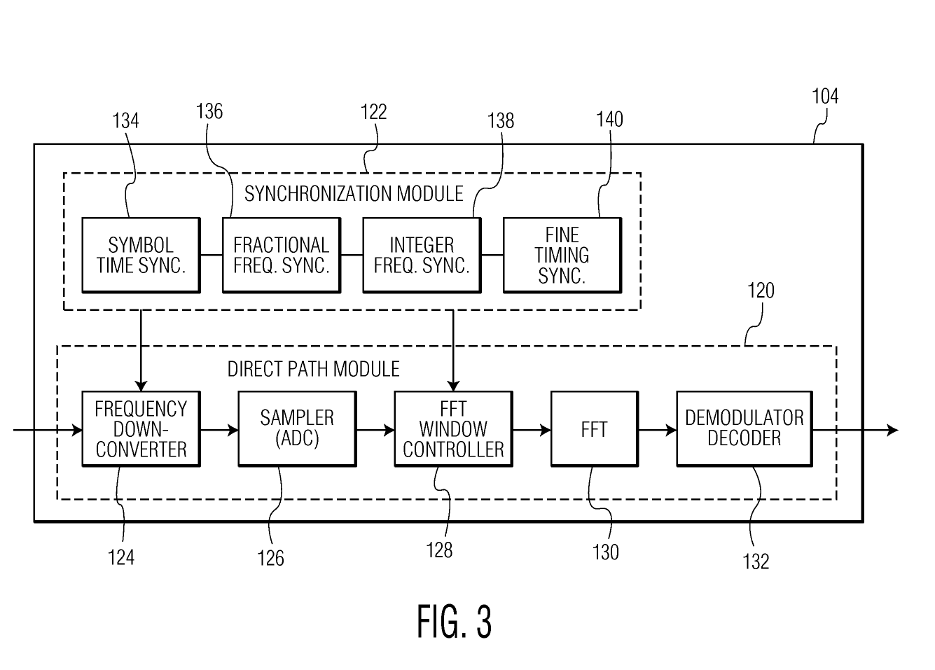

FIG. 3 depicts a schematic block diagram of one embodiment of the OFDM receiver of the OFDM communication system of FIG. 2.

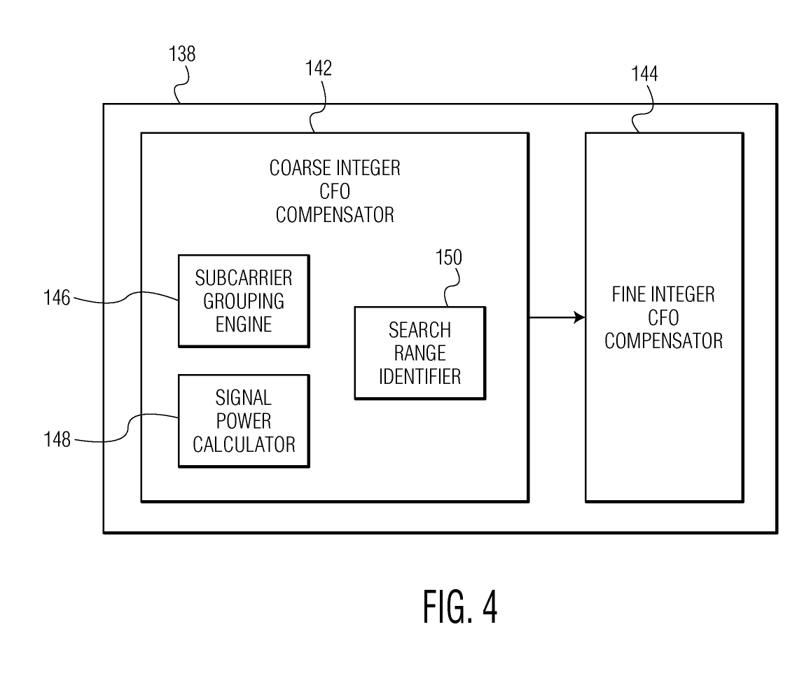

FIG. 4 depicts a schematic block diagram of one embodiment of the integer frequency synchronizer of the synchronization module of FIG. 3.

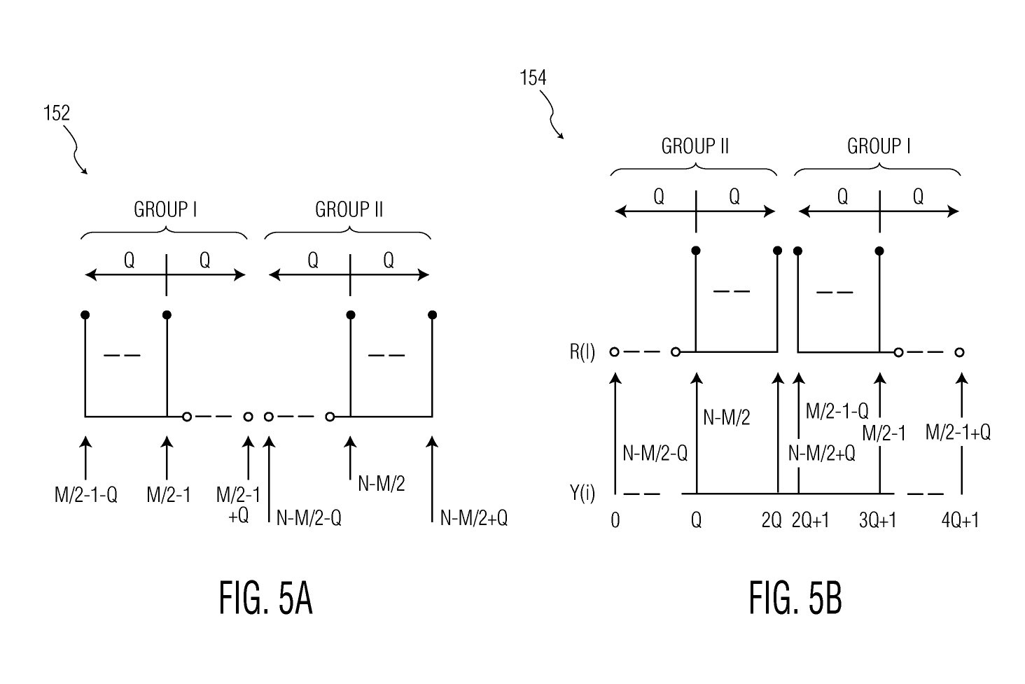

FIG. 5A depicts a schematic graphical representation of one embodiment of grouped subcarriers.

FIG. 5B depicts a schematic graphical representation of one embodiment of rearranged and re-indexed subcarriers.

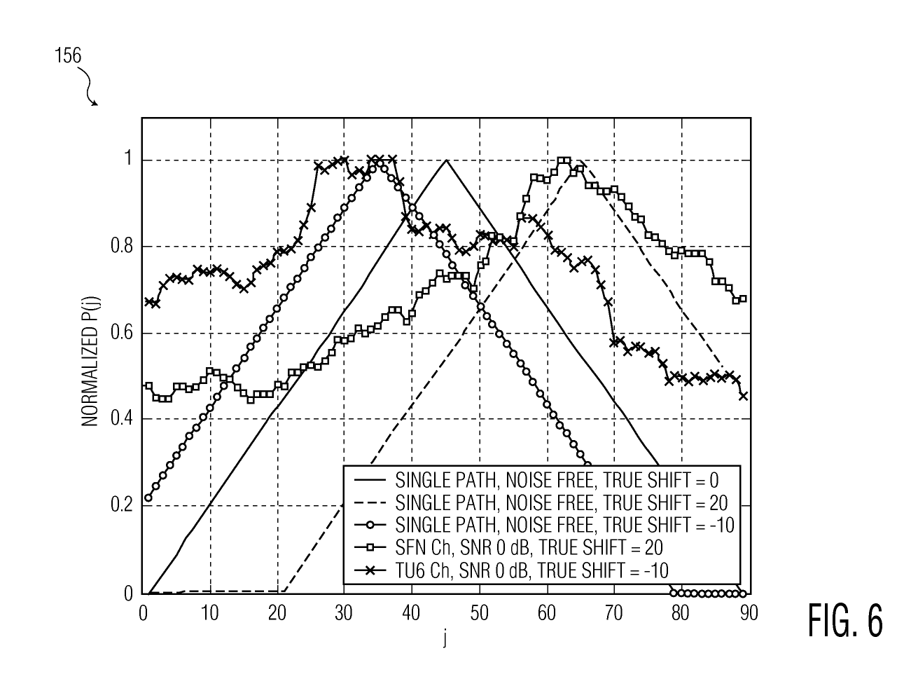

FIG. 6 depicts a schematic graphical representation of embodiments of a normalized signal power.

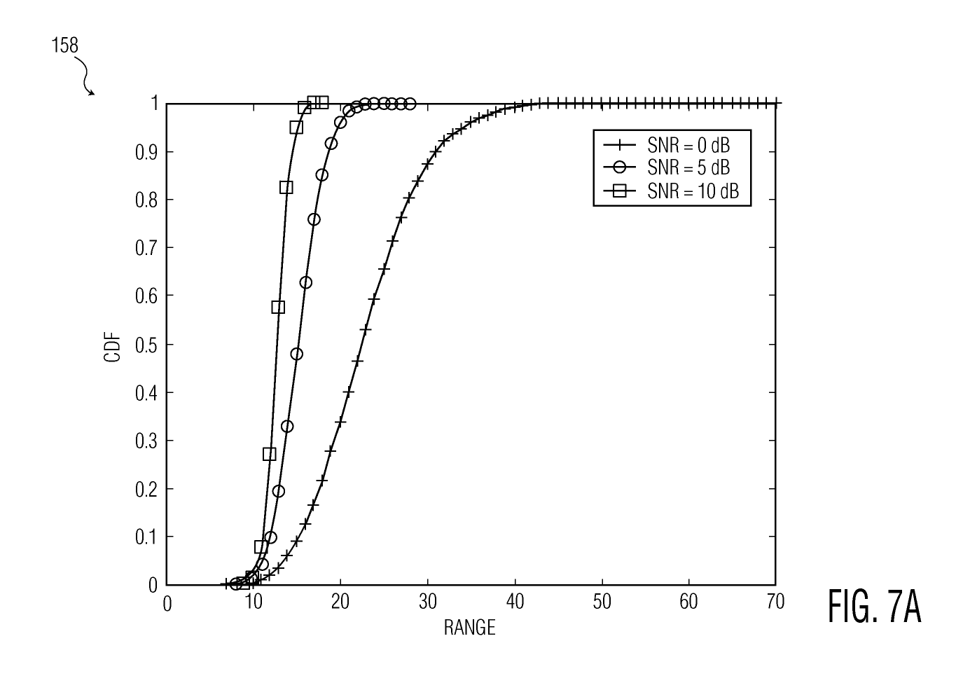

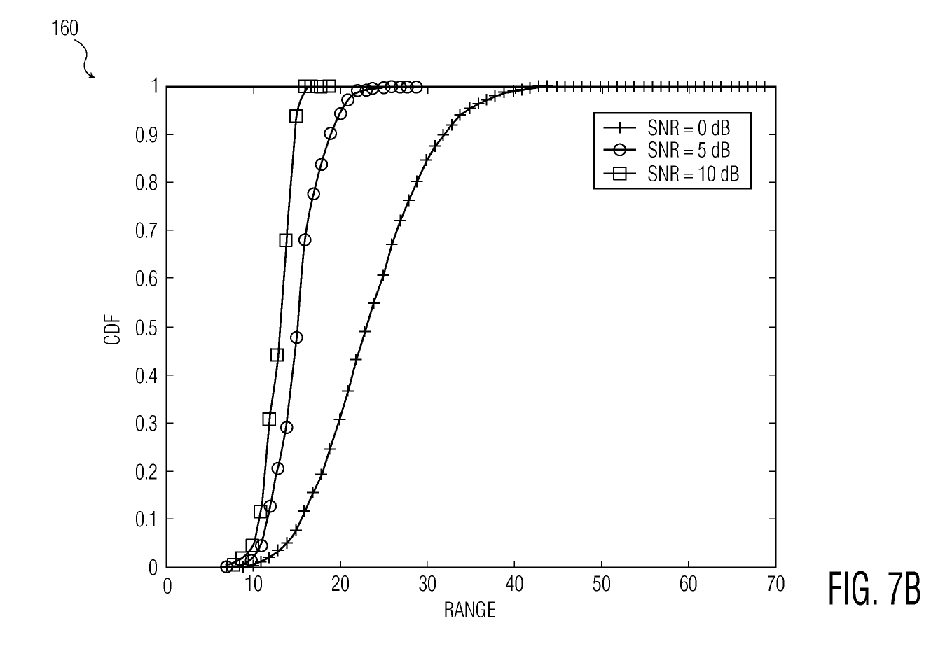

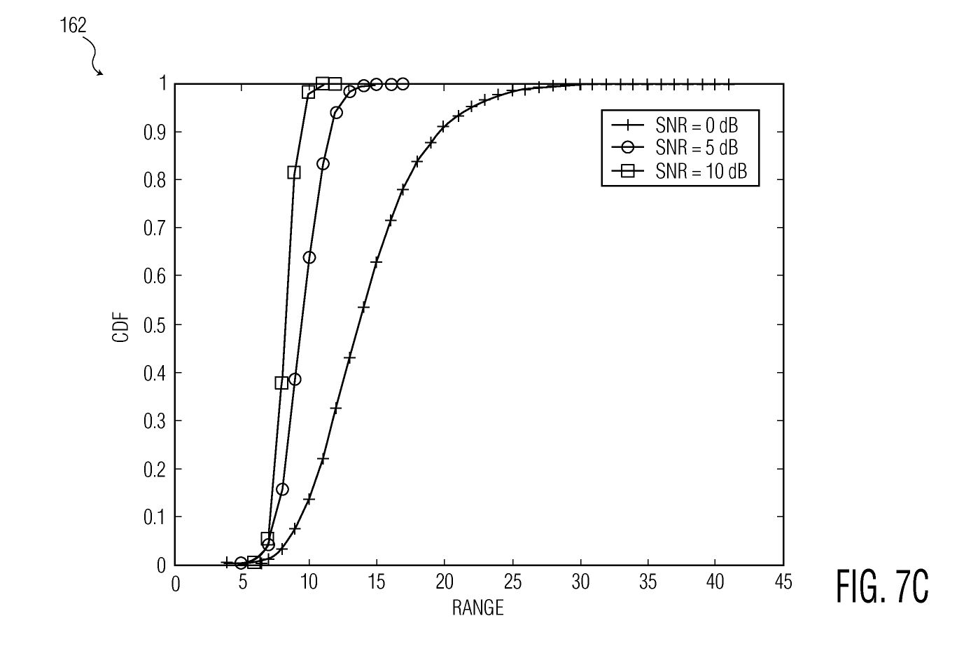

FIGS. 7A-C depict schematic graphical representations of cumulative distribution function (CDF) values based on determined ranges for additive white Gaussian noise (AWGN) of a single path, a single-frequency network (SFN) multi-path channel, and a typical urban channel with 6 taps (TU6) multi-path channel.

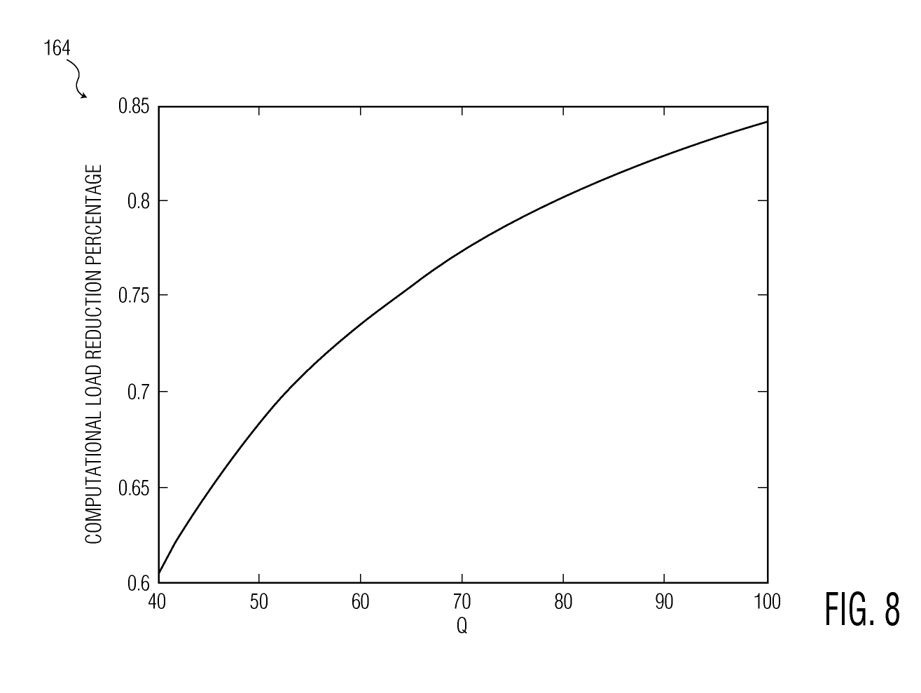

FIG. 8 depicts a schematic graphical representation of computational load reduction percentage based on values for an acquisition range, Q.

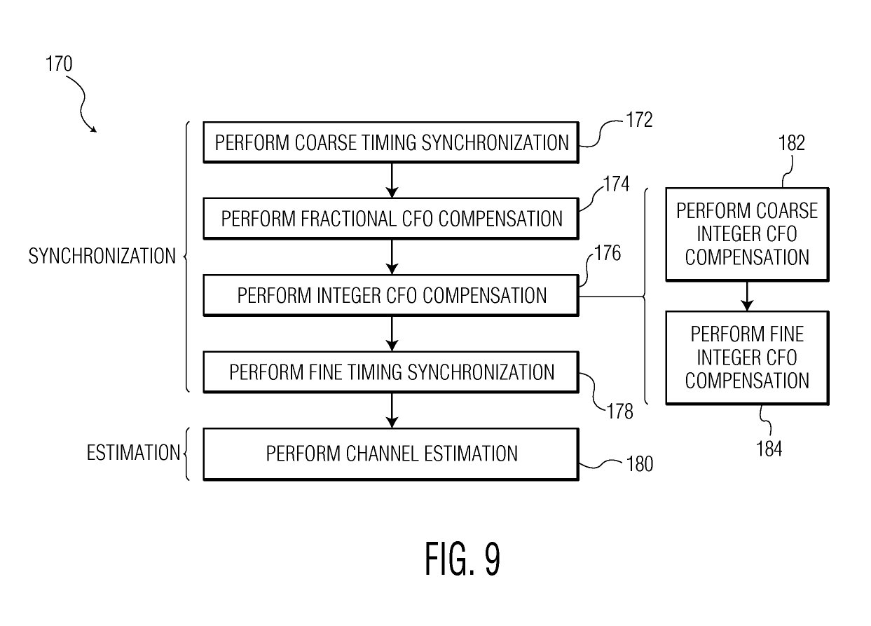

FIG. 9 depicts a schematic flow chart diagram of one embodiment of a synchronization method for synchronizing the OFDM receiver with the OFDM transmitter in the OFDM communication system of FIG. 2.

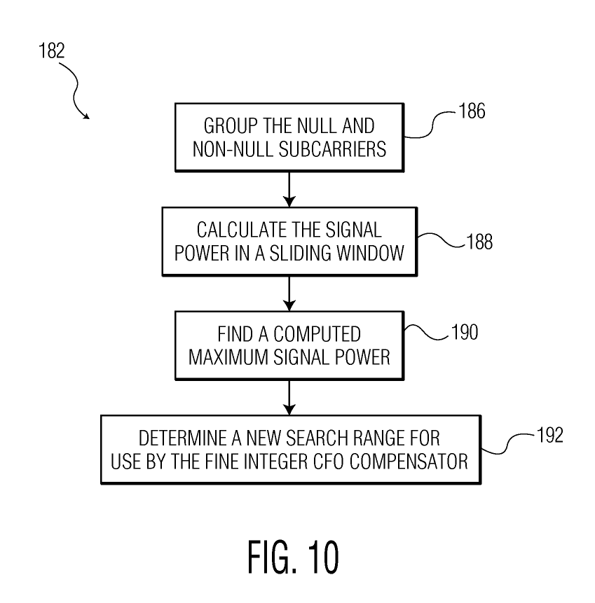

FIG. 10 depicts a schematic flow chart diagram of one embodiment of the integer CFO compensation operation of the synchronization method of FIG. 9. Throughout the description, similar reference numbers may be used to identify similar elements.

While many embodiments are described herein, at least some of the described embodiments facilitate a low complexity CFO estimation scheme for OFDM. In some embodiments, the integer CFO estimator includes two estimation stages: a coarse integer CFO estimation stage and a fine integer CFO estimation stage. Embodiments of the coarse integer CFO estimation stage are conducted based on the detection of subcarrier signal power. The resultant estimate of the coarse integer CFO estimation stage may be used to define a narrower range for a global search in the fine integer CFO estimation stage. In some embodiments, the computational complexity of the overall integer CFO estimation process is reduced, relative to conventional techniques, by implementing a coarse integer CFO estimation stage to define the fine acquisition range for the subsequent fine integer CFO estimation stage. Additionally, some embodiments may use existing estimation algorithms. For example, some embodiments implement a conventional fine integer CFO estimator with high accuracy to deliver the final estimate of the integer CFO. In this way, embodiments which implement the coarse and fine integer CFO estimation stages incur relatively low estimation complexity while maintaining relatively high accuracy.

FIG. 2 depicts a schematic block diagram of one embodiment of an OFDM communication system 100. The illustrated OFDM communication system 100 includes an OFDM transmitter 102 and an OFDM receiver 104. The OFDM transmitter 102 includes a transmitter oscillator 106 and a transmitting antenna 108. Similarly, the OFDM receiver 104 includes a receiver oscillator 110 and a receiving antenna 112. Although the depicted OFDM communication system 100 includes several functional blocks described herein, other embodiments of the OFDM communication system 100 may include fewer or more functional blocks to implement more or less functionality. Additionally, the designations of “transmitter” and “receiver” are not exclusive in that the OFDM transmitter 102 also may have functionality to receive OFDM signals and/or the OFDM receiver 104 may have functionality to transmit OFDM signals.

In general, the transmitter oscillator 106 generates a transmitter oscillator signal. The receiver oscillator 110 generates a corresponding receiver oscillator signal. In order to facilitate efficient OFDM communications between the OFDM transmitter 102 and the OFDM receiver 104, the receiver oscillator signal from the receiver oscillator 110 may be synchronized with the transmitter oscillator signal from the transmitter oscillator 106. In this way, a mismatch between the receiver oscillator signal and the transmitter oscillator signal may be corrected, or otherwise compensated for.

It should be noted that the timing synchronization and the fractional CFO compensation which may be implemented by the OFDM receiver 104 are not described in detail herein. In some embodiments, the description herein assumes a noise free environment in which the fractional CFO is properly compensated. A received OFDM symbol, in a discrete form, is given by:

$$r ( k ) = \frac{1}{N} {\sum }_{n = 0}^{N - 1} X ( n ) H ( n ) {e}^{j2π ( n + {ζ}_{I} ) \frac{k}{N}} , 0 \leq k \leq N - 1$$

where X(n) denotes the data sequence in the frequency domain, H(n) denotes the channel transfer function (CTF) on the n-th subcarrier, N denotes the number of subcarriers, and \tilde{ζ}_{I}, denotes the integer CFO, respectively. The N point FFT of r(k) is:

$$\begin{matrix}R ( l ) = {\sum }_{k = 0}^{N - 1} r ( k ) {e}^{- j 2 π k \frac{l}{N}} \\ = {\sum }_{k = 0}^{N - 1} [ \frac{1}{N} {\sum }_{n = 0}^{N - 1} X ( n ) H ( n ) {e}^{j2π ( n + {ζ}_{I} ) \frac{k}{N}} ] \cdot {e}^{- j2π k \frac{l}{N}} \\ = \frac{1}{N} {\sum }_{n = 0}^{N - 1} X ( n ) H ( n ) {\sum }_{k = 0}^{N - 1} {e}^{j2π \frac{( n + {ζ}_{I} ) - l}{N} k}\end{matrix}$$

Since the integer CFO, \tilde{ζ}_{I}, is an integer, the N point FFT is only meaningful when n=l−\tilde{ζ}_{I}. Therefore, the l-th bin of the FFT output is:

R(l)=X((l−\tilde{ζ}_{I})mod N)H((l−\tilde{ζ}_{I})mod N), 0≦l≦N−1

Hence, based on this equation, the integer CFO causes a cyclic shift of the entire spectrum. For reference, and without loss of generality, Q is used herein to denote the initial acquisition range used in the integer CFO estimation process.

FIG. 3 depicts a schematic block diagram of one embodiment of the OFDM receiver 104 of the OFDM communication system 100 of FIG. 2. The illustrated OFDM receiver 104 includes a demodulator 120 and a synchronization module 122. Although the depicted OFDM receiver 104 includes several functional blocks described herein, other embodiments of the OFDM receiver 104 may include fewer or more functional blocks to implement more or less functionality. For example, although not shown in FIG. 3, the OFDM receiver 14 also includes a receiver oscillator 110, as shown in FIG. 2 and described above.

In general, the demodulator 120 demodulates an OFDM signal from a transmitter such as the OFDM transmitter 102. The illustrated demodulator 120 includes a frequency down-converter 124, a sampler 126 such as an analog-to-digital converter (ADC), a fast Fourier transform (FFT) window controller 128, a FFT module 130, and a demodulator decoder 132. These functional blocks operate according to conventional demodulation techniques and, hence, are not described in more detail herein. Other embodiments of the demodulator 128 may include fewer or more functional blocks.

In one embodiment, the synchronization module 122 is coupled to the demodulator 120 and the receiver oscillator 110. In general, the synchronization module 122 synchronizes the receiver oscillator signal from the receiver oscillator 110 with the transmitter oscillator signal from the transmitter oscillator 108. The depicted synchronization module 122 includes a symbol time synchronizer 134, a fractional frequency synchronizer 136, an integer frequency synchronizer 138, and a fine timing synchronizer 140. In some contexts, these functional blocks may be referred to using different terminology. For example, the symbol time synchronizer 134 also may be referred to as a coarse timing synchronizer. Also, the fractional and integer frequency synchronizers 136 and 138 may be referred to as fractional and integer CFO compensators, respectively. Unless noted otherwise, the various terminology used herein to designate the functional blocks of the synchronization module 122 are interchangeable and are not limiting as to the functionality available from a block referred to by a particular name. Additionally, other embodiments of the synchronization module 122 may include fewer or more functional blocks to implement more or less functionality.

As explained above, embodiments of the symbol time synchronizer 134, the fractional frequency synchronizer 136, and the fine timing synchronizer 140 are not described in detail herein. Accordingly, the synchronization module 122 may implement any combination of conventional symbol timing synchronizers and 134, fractional frequency synchronizers 136, and fine timing synchronizers 140.

In one embodiment, the integer frequency synchronizer 138, which is also referred to as the integer CFO compensator 138, implements a coarse CFO estimation stage and a fine CFO estimation stage. In general, the coarse CFO estimation stage provides a fine acquisition range for the fine CFO estimation stage. Embodiments of the coarse CFO estimation stage and the fine CFO estimation stage are described in more detail below with reference to FIG. 4.

FIG. 4 depicts a schematic block diagram of one embodiment of the integer frequency synchronizer 138 of the synchronization module 122 of FIG. 3. As explained above, the integer frequency synchronizer 138 is also referred to interchangeably as the integer CFO compensator 138. The illustrated integer frequency synchronizer 138 includes a coarse integer CFO compensator 142 and a fine integer CFO compensator 144. Other embodiments of the integer frequency synchronizer 138 may include fewer or more functional blocks. For convenience, since many embodiments of the integer frequency synchronizer 138 may implement conventional fine integer CFO compensators, embodiments of the fine integer CFO compensator 144 are not described in more detail herein.

In the illustrated embodiment, the coarse integer CFO compensator 142 includes a subcarrier grouping engine 146, a signal power calculator 148, and a search range generator 150. In general, the subcarrier grouping engine 146 groups subcarriers into two groups based on a coarse acquisition range parameter, Q, corresponding to a coarse acquisition range. The signal power calculator 148 identifies a coarse estimate of an integer CFO based on a computed maximum value of a signal power function, which is based on a constructed sequence of the subcarriers. Using the computed maximum value of the signal power function, the search range generator 150 identifies a fine acquisition range, which is narrower than the coarse acquisition range. The fine integer CFO compensator 144 may use the fine acquisition range identified by the search range generator 150 in order to estimate the integer CFO with greater accuracy.

More specifically, in some embodiments, the subcarrier grouping engine 146 groups subcarriers into two groups. Each group of subcarriers includes null and non-null subcarriers. As explained above, some null subcarriers may be inserted at both sides of the spectrum to facilitate filter design. In one embodiment, the subcarriers are divided into groups based on two separate ranges of indices. As an example, the first range may correspond to

$$\frac{M}{2} - 1 - Q ∼ \frac{M}{2} - 1 + Q ,$$

and the second range may correspond to

$$N - \frac{M}{2} - Q ∼ N - \frac{M}{2} + Q .$$

In these ranges, N represents a total number of the null and non-null subcarriers within a spectrum, M represents a total number of the non-null subcarriers within the spectrum, and Q represents the coarse acquisition range parameter for the coarse acquisition range. FIG. 5A depicts a schematic graphical representation of one embodiment of grouped subcarriers 152, as described herein. The coarse acquisition range for each group extends between −Q and Q, inclusive. For convenience, the illustrated groups are labeled as Group I and Group II.

In some embodiments, the subcarrier grouping engine 146 also rearranges the two groups of subcarriers to institute a rearranged order of the subcarriers. The subcarrier grouping engine 146 also may assign new indices to the subcarriers in the rearranged order. In some embodiments, the new indices correspond to the constructed sequence of the subcarriers of the OFDM signal. As an example, using the indices and ranges described above, the subcarriers in Group I and Group II may be swapped and new indices may be applied to the subcarriers in the swapped arrangement. FIG. 5B depicts a schematic graphical representation of one embodiment of rearranged and re-indexed subcarriers 154.

In one embodiment, the new index, Y(i), for the rearranged the subcarriers can be expressed mathematically by R(l), as follows:

$$Y ( i ) = \{ \begin{matrix}R ( i + N - \frac{M}{2} - Q ) , & 0 \leq i \leq 2 Q \\ R ( i - 3 Q + \frac{M}{2} - 2 ) , & 2 Q + 1 \leq i \leq 4 Q + 1\end{matrix}$$

Hence, the new index, Y(i), applies over the range of 0≦i≦4Q+1. It should also be noted that these exemplary groupings are based on an assumption that the initial acquisition range is −Q≦\tilde{ζ}_{I}≦Q.

In one embodiment, the signal power calculator 148 calculates a signal power of the subcarriers over a sliding window. As an example, a signal power calculator 148 may calculate the signal power according to:

$$P ( j ) = {\sum }_{i = j}^{2 Q + j} {\vert Y ( i ) \vert}^{2} , 0 \leq j \leq 2 Q + 1$$

where Y(i) represents the new index function to assign the new indices to the subcarriers in the rearranged order according to the constructed sequence of the plurality of subcarriers.

As a practical implementation, the signal power may be calculated with an iterative formula, as follows:

P(j)=P(j−1)+|Y(2Q+j)|²−|Y(j)|²

The signal power calculator 148 may use the signal power calculations to identify a computed maximum value of the signal power function in order to identify the coarse estimate of the integer CFO, as explained above. The coarse estimation, as explained herein, is based on the constructed sequence using the new index function, Y(i). If all the signal components are covered in the sliding window, P(j) reaches the computed maximum value, and the coarse integer CFO is obtained by \tilde{ζ}_{I}=j−Q. Thus, the coarse estimation of the integer CFO may be summarized as follows:

$${\hat{ζ}}_{I} = {arg max}_{j} P ( j ) - Q$$

where P(j) is calculated according to the equations and description above. Other embodiments may use other implementations and/or formulas to calculate the signal power over a sliding window.

Using computer simulations, it may be possibly to analyze the calculations for the coarse CFO estimation algorithm. Assuming that the sampling rate is 10 MHz, the cyclic prefix length is 51.2 μs, N=2048, and M=1536, two exemplary multi-path channels, i.e., TU6 and SFN, may be analyzed. The corresponding channel profiles are shown in Table I.

TABLE I
Channel profile of multi-path channel TU6 and SFN

| | TU6 Channel | | SFN Channel | |
|---|---|---|---|---|
| | Path Delay | Avg. Power | Path Delay | Avg. Power |
| Path | (nsec) | (dB) | (nsec) | (dB) |
| 1 | 0 | −3.0 | 0 | 0.0 |
| 2 | 200 | 0.0 | 48600 | 0.0 |
| 3 | 500 | −5.0 | | |
| 4 | 1600 | −6.0 | | |
| 5 | 2300 | −8.0 | | |
| 6 | 5000 | −10.0 | | |

FIG. 6 depicts a schematic graphical representation of embodiments of a normalized signal power, according to the simulation parameters described above. In an ideal environment, e.g., noise free and no multi-path fading, simulated embodiments the coarse integer CFO estimation method described herein are able to identify the correct integer CFO. This exemplary calculation of the signal power, P(j), involves 8Q+4 multiplications. In the case of Q=44, the total number of multiplications is 356. However, under a low SNR and severe frequency selectivity circumstances, the correctness of the coarse integer CFO estimation stage cannot necessarily be ensured. Nevertheless, the coarse integer CFO estimate can be used to set a new search range for the subsequent fine integer CFO estimation.

In one embodiment the search range generator 150 identifies a lower bound, a, and an upper bound, b, of the fine acquisition range. Hence, the fine acquisition range extends between a and b, inclusive. In some embodiments, the lower and upper bounds, a and b, of the fine acquisition range are approximately located at a fractional signal power relative to the computed maximum of the signal power function. An exemplary fractional signal power is 85% of the computed maximum value of the signal power function.

In one embodiment, based on the obtained signal power, P(j), 0≦j≦2Q+1, the lower bound, a, is the index of the first signal power value which is larger than Max{P}×0.85 when j is increasing from 0 to 2Q+1. In contrast, the lower bound, b, is the index of the first signal power value which is larger than Max{P}×0.85 when j is decreasing from 2Q+1 to 0. This searching process is described as:

$$a = {arg}_{j , j = 0 \to 2 Q + 1} \{ P ( j ) \geq Max \{ P \} \times 0.85 \} , and$$

$$b = {arg}_{j , j = 2 Q + 1 \to 0} \{ P ( j ) \geq Max \{ P \} \times 0.85 \}$$

Thus, in one embodiment, the determination of the lower and upper bounds, a and b, of the fine acquisition range is based on the index of the first corresponding signal power that meets the selected condition. Although some embodiments may use an exemplary multiplier of 0.85, other embodiments may use other fractional multipliers for the fine acquisition range relative to the computed maximum value of the signal power function, as described above.

Using embodiments of the coarse integer CFO compensator 142, the original coarse acquisition range [−Q,Q] may be narrowed, or shrunk, to [a,b], where a≧−Q and b≦Q. Thus, the computational complexity of the accurate fine integer CFO estimation stage is reduced to

$$\frac{b - a + 1}{2 Q + 1}$$

times the original computational load. As in FIG. 6, under the multi-path circumstance (i.e., TU6 Ch, SNR 0dB, True Shift=−10, Q=44), a=24 and b=37, the computational complexity of the fine estimation is reduced by 85.3% in this case, compared to conventional estimation techniques. While simulations and analysis with only one channel realization are described herein, other embodiments may implement multiple channel realizations. It should also be noted that the true integer CFO, \tilde{ζ}_{I}, should be in the fine acquisition range [a,b]. Otherwise, it may be impossible for the fine integer CFO compensator 144 to determine the correct integer CFO. Exemplary simulation results may be used to verify the effectiveness of the proposed estimation scheme, as shown in Table II.

TABLE II
Probability that ζ₁ is in the range [a, b]

| SNR | AWGN | TU6 Channel | SFN Channel |
|---|---|---|---|
| 0 dB | P{ζ₁ ε[a, b]} = 100% | P{ζ₁ ε[a, b]} = 100% | P{ζ₁ ε[a, b]} = 100% |
| 5 dB | P{ζ₁ ε[a, b]} = 100% | P{ζ₁ ε[a, b]} = 100% | P{ζ₁ ε[a, b]} = 100% |
| 10 dB | P{ζ₁ ε[a, b]} = 100% | P{ζ₁ ε[a, b]} = 100% | P{ζ₁ ε[a, b]} = 100% |

FIGS. 7A-C depict schematic graphical representations 158, 160, and 162 of cumulative distribution function (CDF) values based on determined ranges for additive white Gaussian noise (AWGN) of a single path (see FIG. 7A), a single-frequency network (SFN) channel (see FIG. 7B), and a TU6 channel (see FIG. 7C). In general, 90% of the resultant range is less than 32.

As explained above, any one of several conventional fine integer CFO compensators may be implemented in conjunction with the coarse integer CFO compensator 142 described herein. One well-known fine integer CFO estimation method is the S&C method proposed by T. Schmidl and D. Cox in “Robust frequency and timing synchronization for OFDM,” IEEE Trans. on Comm., Vol. 45, No. 12, December 1997, pp. 1613-1621.

Using a conventional fine integer CFO estimation method, and assuming that the there are Nₚ pilots inserted in the frequency domain, the fine integer CFO estimator 144 of the integer frequency synchronizer 138 implements 4Nₚ multiplications to calculate the correlation for one possible integer CFO. The total number of multiplications is 4Nₚ (2Q+1) for conventional methods. As a specific example using a conventional fine integer CFO estimation method, the total number of multiplications is 35600 for Nₚ=100 and Q=44. In contrast, by using an embodiment of the coarse integer CFO compensator 142 described herein, and assuming that the determined fine acquisition range after the coarse processing is 32, the total number of multiplications is now 12800 by the fine integer CFO compensator 144, plus 356 which are implemented by the coarse integer CFO compensator 142 during the coarse integer CFO estimation stage. As Q increases, the reduction in multiplication operations becomes even more significant. Basically, any conventional fine integer CFO compensator with ultimate accuracy can be adopted. Regardless of the algorithm used, embodiments of the proposed coarse integer CFO estimation scheme can reduce the computational load, for example, by

$$1 - \frac{32}{2 Q + 1}$$

in 90% atypical cases. FIG. 8 depicts a schematic graphical representation 164 of computational load reduction percentage based on values for an acquisition range dependent on Q.

FIG. 9 depicts a schematic flow chart diagram of one embodiment of a synchronization method 170 for synchronizing the OFDM receiver 104 with the OFDM transmitter 102 in the OFDM communication system 100 of FIG. 2. Although the synchronization method 170 is described in conjunction with the OFDM communication system 100 of FIG. 2, other embodiments of the synchronization method 170 may be implemented with other OFDM communication systems.

The depicted synchronization method 170 includes two general stages—synchronization and estimation. The operations corresponding to the synchronization and estimation stages of the synchronization method 170 are indicated in FIG. 9. At block 172, the symbol time synchronizer 134 performs coarse timing synchronization. At block 174, the fractional frequency synchronizer 136 performs fractional CFO compensation. At block 176, the integer frequency synchronizer 138 performs integer CFO compensation. At block 178, the fine timing synchronizer 140 performs fine timing synchronization, and the synchronization stage of the synchronization method 170 ends. The estimation stage follows the synchronization stage and, at block 170, channel estimation is implemented. In one embodiment, the demodulator decoder 132 performs the channel estimation. The depicted synchronization method 170 then ends.

While several of the operations of the synchronization method 170 are not described in detail herein, the integer CFO compensation operation 176 includes two sub-operations. The first sub-operation of the integer CFO compensation operation 176 is the coarse integer CFO estimation stage. More specifically, at block 182, the coarse integer CFO compensator 142 performs coarse integer CFO compensation. Exemplary functions of the coarse integer CFO compensation sub-operation 182 are shown in FIG. 10 and described in more detail below. The second sub-operation of the integer CFO compensation operation 176 is the fine integer CFO estimation stage. More specifically, at block 184, the fine integer CFO compensator 144 performs fine integer CFO compensation. Together, the coarse integer CFO compensation sub-operation 182 and the fine integer CFO compensation sub-operation 184 facilitate the integer CFO compensation operation 176 of the synchronization method 170.

FIG. 10 depicts a schematic flow chart diagram of one embodiment of the coarse integer CFO compensation sub-operation 182 of the synchronization method 170 of FIG. 9. Although the coarse integer CFO compensation sub-operation 182 is described in conjunction with the OFDM communication system 100 of FIG. 2, other embodiments of the coarse integer CFO compensation sub-operation 182 may be implemented with other OFDM communication systems.

In general, the coarse integer CFO compensation sub-operation 182 includes generating an oscillation signal at the OFDM receiver 104, generating a coarse integer CFO estimation for an OFDM signal received at the OFDM receiver 104, generating a fine integer CFO estimation based on the coarse integer CFO estimation, and synchronizing the oscillation signal at the OFDM receiver 104 with a transmitter oscillation signal based at least partially on the fine integer CFO estimation.

More specifically, at block 186, the subcarrier grouping engine 146 groups the subcarriers of the received OFDM signal. As explained above, one or more null subcarriers may be combined with the non-null subcarriers. At block 188, the signal power calculator 148 calculates a signal power in a sliding window. At block 190, a signal power calculator 148 finds a computed maximum signal power. At block 192, the search range generator 150 determines a new search range for use by the fine integer CFO compensator 144. The depicted coarse integer CFO compensation sub-operation 182 then ends.

Other embodiments of the synchronization method 170 and/or the coarse integer CFO compensation sub-operation 22 may implement fewer or more operations. In particular, some embodiments of the synchronization method 170 and/or the coarse integer CFO compensation sub-operation 182 facilitate implementation of any of the functions described in relation to the OFDM communication system 100 or any of the components thereof.

In some embodiments, the coarse integer CFO compensator 142 described above facilitates a relatively low complexity integer CFO estimator. In some embodiments, the conventional integer CFO compensation technique is separated into two successive stages—a coarse estimation stage and a fine estimation stage, as described above. For fine estimation algorithms with ultimate accuracy, a significant computational load corresponds to the global search for the correlation peak. Embodiments of the coarse processing techniques described herein are capable of limiting and shrinking the search range. Therefore, the computational complexity of the subsequent fine estimation process may be reduced significantly, for example, by

$$1 - \frac{32}{2 Q + 1}$$

in 90% of the cases. It should also be noted that the embodiments described herein may be applied to any general OFDM system with null subcarriers inserted at the two sides of the spectrum.

At least some of the operations for the synchronization method 170 and the OFDM communication system 100 may be implemented using software instructions stored on a computer useable storage medium for execution by a computer. As an example, an embodiment of a computer program product includes a computer useable storage medium to store a computer readable program that, when executed on a computer, causes the computer to perform operations, as described above.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable storage medium providing program code for use by or in connection with a computer or any instruction execution system. For the purposes of this description, a computer-usable or computer readable storage medium can be any apparatus that can store the program for use by or in connection with the instruction execution system, apparatus, or device.

The computer-useable or computer-readable storage medium can be an electronic, magnetic, optical, electromagnetic, infrared, or semiconductor system (or apparatus or device), or a propagation medium. Examples of a computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), a digital video disk (DVD), and high-definition (HD) disks such as Blu-Ray and HD-DVD.

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A coarse integer carrier frequency offset (CFO) compensator comprising:
a subcarrier grouping engine to group a plurality of subcarriers into two groups based on a coarse acquisition range parameter, Q, corresponding to a coarse acquisition range;
a signal power calculator coupled to the subcarrier grouping engine, the signal power calculator to identify a coarse estimate of an integer CFO based on a computed maximum value of a signal power function, wherein the signal power function is based on a constructed sequence of the plurality of subcarriers; and
a search range generator coupled to the signal power calculator, the search range generator to identify a fine acquisition range, wherein the fine acquisition range is narrower than the coarse acquisition range.

2. The coarse integer CFO compensator of claim 1, wherein each group of subcarriers includes a plurality of null and non-null subcarriers.

3. The coarse integer CFO compensator of claim 2, wherein the subcarrier grouping engine is further configured to group the plurality of subcarriers into first and second groups, wherein the first group comprises a first subset of the null and non-null subcarriers within a first range of
$$\frac{M}{2} - 1 - Q ∼ \frac{M}{2} - 1 + Q ,$$
and the second group comprises a second subset of the null and non-null subcarriers within a second range of
$$N - \frac{M}{2} - Q ∼ N - \frac{M}{2} + Q ,$$
where N represents a total number of the null and non-null subcarriers within a spectrum, M represents a total number of the non-null subcarriers within the spectrum, and Q represents the coarse acquisition range parameter for the coarse acquisition range, wherein the coarse acquisition range extends between −Q and Q, inclusive.

4. The coarse integer CFO compensator of claim 3, wherein the subcarrier grouping engine is further configured to rearrange the two groups of subcarriers to institute a rearranged order of the plurality of subcarriers.

5. The coarse integer CFO compensator of claim 4, wherein the subcarrier grouping engine is further configured to assign new indices to the subcarriers in the rearranged order, wherein the new indices correspond to the constructed sequence of the plurality of subcarriers of the OFDM signal.

6. The coarse integer CFO compensator of claim 5, wherein the signal power calculator is further configured to calculate a signal power over a sliding window.

7. The coarse integer CFO compensator of claim 6, wherein the signal power calculator is further configured to calculate the signal power according to:
$$P ( j ) = {\sum }_{i = j}^{2 Q + j} {\vert Y ( i ) \vert}^{2} , 0 \leq j \leq 2 Q + 1$$
where Y(i) represents a new index function to assign the new indices to the subcarriers in the rearranged order according to the constructed sequence of the plurality of subcarriers.

8. The coarse integer CFO compensator of claim 7, wherein the signal power calculator is further configured to iteratively calculate the signal power according to:
P(j)=P(j−1)+|Y(2Q+j)|²−|Y(j)².

9. The coarse integer CFO compensator of claim 3, wherein the search range generator is further configured to identify a lower bound, a, and an upper bound, b, of the fine acquisition range, wherein the fine acquisition range extends between a and b, inclusive.

10. The coarse integer CFO compensator of claim 9, wherein the lower and upper bounds, a and b, of the fine acquisition range are approximately located at a fractional signal power relative to the computed maximum value of the signal power function.

11. The coarse integer CFO compensator of claim 10, wherein the fractional signal power is approximately 85% of the computed maximum value of the signal power function.

12. A receiver for orthogonal frequency division multiplexing (OFDM) communications, the receiver comprising:
a receiver oscillator to generate an oscillation signal;
a demodulator to demodulate an OFDM signal from a transmitter; and
a synchronization module coupled to the demodulator and the receiver oscillator, the synchronization module to synchronize the receiver oscillator with a transmitter oscillator at the transmitter, wherein the synchronization module comprises:
an integer carrier frequency offset (CFO) compensator to implement a coarse CFO estimation stage and a fine CFO estimation stage, wherein the coarse CFO estimation stage is configured to provide a fine acquisition range for the fine CFO estimation stage.

13. The receiver of claim 12, wherein the integer CFO compensator comprises a subcarrier grouping engine to group a plurality of subcarriers of the OFDM signal into two groups based on a coarse acquisition range parameter, Q, corresponding to a coarse acquisition range.

14. The receiver of claim 13, wherein the integer CFO compensator further comprises a signal power calculator coupled to the subcarrier grouping engine, the signal power calculator to identify a coarse estimate of an integer CFO based on a computed maximum value of a signal power function, wherein the signal power function is based on a constructed sequence of the plurality of subcarriers of the OFDM signal.

15. The receiver of claim 14, wherein the integer CFO compensator further comprises a search range generator coupled to the signal power calculator, the search range generator to identify the fine acquisition range, wherein the fine acquisition range is narrower than the coarse acquisition range.

16. The receiver of claim 14, wherein the subcarrier grouping engine is further configured to group the plurality of subcarriers into first and second groups, wherein the first group comprises a first subset of the null and non-null subcarriers within a first range of
$$\frac{M}{2} - 1 - Q ∼ \frac{M}{2} - 1 + Q ,$$
and the second group comprises a second subset of the null and non-null subcarriers within a second range of
$$N - \frac{M}{2} - Q ∼ N - \frac{M}{2} + Q ,$$
where N represents a total number of the null and non-null subcarriers within a spectrum, M represents a total number of the non-null subcarriers within the spectrum, and Q represents the coarse acquisition range parameter for the coarse acquisition range, wherein the coarse acquisition range extends between −Q and Q, inclusive.

17. The receiver of claim 16, wherein the subcarrier grouping engine is further configured to rearrange the two groups of subcarriers to institute a rearranged order of the plurality of subcarriers, and to assign new indices to the subcarriers in the rearranged order, wherein the new indices correspond to the constructed sequence of the plurality of subcarriers of the OFDM signal.

18. A method for compensating for an integer carrier frequency offset (CFO) at an orthogonal frequency division multiplexing (OFDM) receiver in an OFDM communication system, the method comprising:
generating an oscillation signal at the OFDM receiver;
generating a coarse integer CFO estimation for an OFDM signal received at the OFDM receiver;
generating a fine integer CFO estimation based on the coarse integer CFO estimation; and
synchronizing the oscillation signal at the OFDM receiver with a transmitter oscillation signal based at least partially on the fine integer CFO estimation.

19. The method of claim 18, further comprising:
grouping a plurality of subcarriers of the OFDM signal into two groups based on a coarse acquisition range parameter, Q, corresponding to a coarse acquisition range;
identifying a coarse estimate of an integer CFO based on a computed maximum value of a signal power function, wherein the signal power function is based on a constructed sequence of the plurality of subcarriers of the OFDM signal; and
identifying a fine acquisition range based on the computed maximum value of the signal power function.

20. The method of claim 19, further comprising:
grouping the plurality of subcarriers into first and second groups, wherein the first group comprises a first subset of the null and non-null subcarriers within a first range of
$$\frac{M}{2} - 1 - Q ∼ \frac{M}{2} - 1 + Q ,$$
and the second group comprises a second subset of the null and non-null subcarriers within a second range of
$$N - \frac{M}{2} - Q ∼ N - \frac{M}{2} + Q ,$$
where N represents a total number of the null and non-null subcarriers within a spectrum, M represents a total number of the non-null subcarriers within the spectrum, and Q represents the coarse acquisition range parameter for the coarse acquisition range, wherein the coarse acquisition range extends between −Q and Q, inclusive;
rearranging the two groups of subcarriers to institute a rearranged order of the plurality of subcarriers; and
assigning new indices to the subcarriers in the rearranged order, wherein the new indices correspond to the constructed sequence of the plurality of subcarriers of the OFDM signal.
